(19) United States
(12) Patent Application Publication
(10) Pub. No.: US 2010/0174743 A1
(43) Pub. Date: Jul. 8, 2010

(54) Information Processing Apparatus and Method

(75) Inventors: Takeshi Komano, Iwata-shi (JP); Shigehiko Mizuno, Hamamatsu-shi (JP); Yasushi Tamazawa, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 12/683,611

(22) Filed: Jan. 7, 2010

(30) Foreign Application Priority Data
Jan. 8, 2009 (JP) 2009-002561

(51) Int. Cl. G06F 17/30; G06F 3/048

(52) U.S. Cl. 707/769; 715/816; 707/E17.008

(57) ABSTRACT

Storage stores therein groups of words in association with individual ones objects of search, each of the groups indicating a character of a corresponding one of the objects, the objects of search being classified redundantly into plural items, the storage storing therein, for each of the items, at least one group of words. Controller mixedly displays, on a display and with reference to the storage, tags indicative of groups of words for the individual items, the controller displaying the tags in different display styles unique to the individual items, an image of each of the tags being variable stepwise in accordance with a predetermined condition. User can select a desired tag from among the displayed tags. Search section searches for an object of search meeting a search condition identified on the basis of the one or more words indicated by the tag selected by the user.

### BACKGROUND

The present invention relates to an information processing apparatus and program for searching for desired information (content) on the basis of a search condition designated by a user, and more particularly to a technique for mixedly displaying a multiplicity of words, defining search conditions, in such different display styles as to allow the words to be visually recognized per each of a plurality of search items (hereinafter sometimes referred to as “items”).

Recently, it is commonly performed to search a multiplicity of pieces of information (so-called content, and more particularly pieces of information, such as web page displaying data, music piece data, video/image data and software programs, pertaining to texts, still images, animations, music pieces and sounds) and then access (e.g., acquire or brows) a piece of information or content searched out. Among the conventionally-known techniques for users to efficiently search for a necessary piece of information from among a multiplicity of pieces of information is a technique called “Tag Cloud”, which displays a plurality of words (specific or abstract words, such as keywords, briefly indicating characters of individual pieces of information) in text format on a screen of a display device by visualizing the words as if they were clouds of various sizes (large and small clouds) floating in the sky. One example of the “Tag Cloud” technique is disclosed in U.S. Patent Application Publication No. 2008-0072145 (hereinafter referred to as “the patent literature”).

According to the “tag cloud” technique disclosed in the above-identified patent literature, words are pre-assigned as tag information to a multiplicity of pieces of searchable information (hereinafter also referred to as “objects of search”, “object-of-search information” or “content”), and groups of one or more words pre-assigned to individual ones of the multiplicity of objects of search are displayed in a list on a screen of a display device with the words arranged two-dimensionally in a predetermined order (e.g., alphabetical order) on the basis of the tag information. More specifically, those words having high frequencies of appearance and search are displayed in a stepwise highlighted (emphasized) fashion (e.g., with displayed styles, such as a font size, font type and font color, varied or differentiated stepwise). In response to a desired word being selected by a user from among the words thus displayed in a tag cloud format, objects of search are searched using the selected word as a search conditions. In this way, the user can not only quickly read through the displayed words but also quickly visually grasp or recognize words of high popularity from the different display styles, and thus, the “Tag Cloud” technique disclosed in the patent literature advantageously allows the user to relatively easily search for and access a desired object of search.

In general, words can be imparted, separately per each of a plurality of items, to individual pieces of content (i.e., objects of search), so that any interested user can search the pieces of content item by item by selecting any of the words imparted for a desired one of the items. For example, for searching of music content, a variety of words are imparted in advance to individual pieces of content per each of a plurality of items, such as a music piece name and keyword, so that a user can search the pieces of content by setting or designating any of the words, imparted to desired (or previously designated) one or ones of the items, e.g. “Cherry” (word) for the music piece name (item) and “Cheerful” (word) for the keyword (item). However, with the prior art technique disclosed in the patent literature in which search conditions are designated in accordance with a “Tag Cloud” display, there is disclosed or suggested no idea of imparting word information for each of a plurality of items, so that it is difficult to search for a desired object of search by designating a desired item. For example, even when a user selects a word “Cheerful” on the “Tag Cloud” display, it is impossible at all to identify whether the user-selected word “Cheerful” designates, as a search condition, a music piece name or a keyword, so that it would take a long time to search for a desired piece of content.

### SUMMARY OF THE INVENTION

In view of the foregoing, it is an object of the present invention to provide an improved information processing apparatus and method which, when words, defining search conditions and indicative of characters of individual pieces of object-of-search information (i.e., content), are to be displayed in different display styles in a so-called “Tag Cloud” display, can visually display to a user a multiplicity of words in such different display styles as to allow the words to be visually recognized item by item.

In order to accomplish the above-mentioned object, the present invention provides an improved information processing apparatus for searching a multiplicity of objects of search for an object of search corresponding to a search condition, comprising: a display device; a storage section which stores therein groups of one or more words in association with individual ones of the multiplicity of objects of search, each of the groups of one or more words indicating a character of a corresponding one of the objects of search, the multiplicity of objects of search being classified redundantly into a plurality of items, the storage section storing therein, for each of the items, at least one group of one or more words indicating a character of a corresponding one of the objects of search; a control section which mixedly displays, on a screen of the display device and with reference to the storage section, tags indicative of groups of one or more words, each indicating a character of a corresponding one of the objects of search, for individual ones of the plurality of items, the control section displaying the tags in different display styles unique to the individual items, an image of each of the tags being variable stepwise in accordance with a predetermined display variation condition; a selection section which accepts user's operation for selecting a desired tag from among the tags displayed on the screen of the display device; a search section which, with reference to the storage section, searches for an object of search meeting a search condition identified on the basis of the one or more words indicated by the tag selected by the user; and a result-of-search presentation section which visually displays on the display device a result of the search performed by the search section.

According to the present invention, when tags of groups of one or more words, each indicating a character of any one of the multiplicity of objects of search, are to be mixedly displayed for the individual items on the screen of the display device, the tags are displayed in display styles differing among, i.e. unique to, the individual items (search items), so that the user can readily grasp, through intuitive visual recognition, to which of the items the words represented by the tags belong. In this way, the present invention can achieve an enhanced efficiency of search operations. Further, because the image of each of the tags is variable stepwise in accordance with the predetermined display variation condition, the present invention can achieve a so-called “tag cloud” display. Thus, the present invention can advantageously apply the “tag cloud” display to a search technique of a type where a plurality of search objects are classified redundantly into a plurality of items and where groups of one or more searching words, each indicative of a character of any one of the search objects, are assigned to the objects of search per each of the items. Namely, even if words indicative of characters of individual objects of search and defining search conditions are mixedly displayed on the display device through a “tag cloud” display, the present invention allows the user to perform search while knowing which item a word selected by the user belongs to and thus permits efficient information search.

Preferably, the information processing apparatus of the present invention further comprises a second selection section which selects one or more of the items to be displayed. For the one or more items selected by the second selection section, the control section mixedly displays, on the screen of the display device, tags each indicative of a group of one or more words indicating a character of a corresponding one of the objects of search.

Namely, according to the present invention, groups of one or more words, indicative of characters of the individual pieces of object-of-search information (content), are pre-assigned to the pieces of object-of-search information for the plurality of items (search items), and these words are mixedly displayed in a tag-cloud format and in different display styles unique to the individual items. Further, the words are displayed in display styles, other than the above-mentioned item-specific display styles, that are varied stepwise in accordance with a predetermined frequency. In this way, the user is allowed to perform information search while knowing which item a word selected by the user belongs to. In addition, the present invention allows the user to easily search information through AND search operations designing words across the plurality of items, which can achieve even further efficient information search.

Furthermore, because the present invention is constructed to allow the user to select desired items to be displayed in a tag cloud display format, the user can perform information search focusing on only a desired item.

The present invention may be constructed and implemented not only as the apparatus invention as discussed above but also as a method invention. Also, the present invention may be arranged and implemented as a software program for execution by a processor such as a computer or DSP, as well as a storage medium storing such a software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is a block diagram showing an embodiment of a general hardware setup of an electronic musical instrument to which is applied an information processing apparatus in accordance with an embodiment of the present invention;

FIG. 2 is a conceptual diagram showing an example data organization of music content data;

FIG. 3 is a conceptual diagram showing an example of a search screen displayed on a display device in the embodiment;

FIG. 4 is a functional block outlining example functions for performing a series of search processes in the embodiment; and

FIGS. 5A and 5B are conceptual diagrams showing examples of search screens displayed on other apparatus to which is applied the information processing apparatus of the present invention.

### DETAILED DESCRIPTION

FIG. 1 is a block diagram showing an embodiment of a general hardware setup of an electronic musical instrument to which is applied an information processing apparatus in accordance with an embodiment of the present invention. To facilitate understanding, the following description will be given in relation to a case where pieces of music content are objects of search. The electronic musical instrument of FIG. 1 is controlled by a microcomputer including a microprocessor unit (CPU) 1, a read-only memory (ROM) 2 and a random access memory (RAM) 3. The CPU 1 controls operation of the entire electronic musical instrument. To the CPU 1 are connected, via a data and address bus1D, the ROM 2, RAM 3, detection circuits 4 and 5, display circuit 6, tone generator/effect circuit 7, storage device 8 and communication interface (IF) 9.

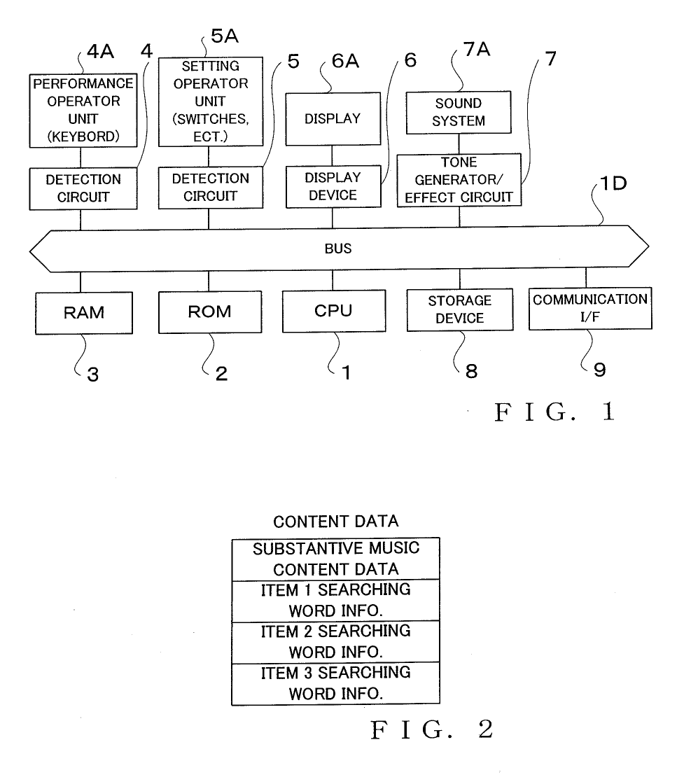

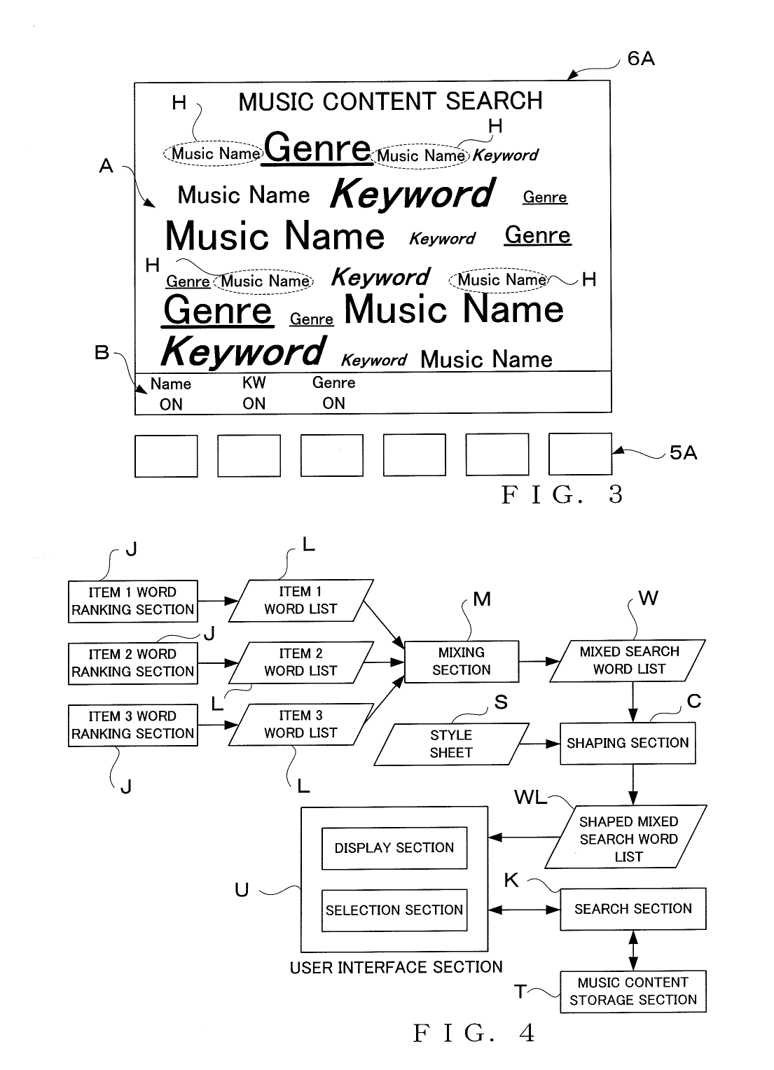

The ROM 2 stores therein various programs for execution by the CPU 1 and various data, such as later-described music content data (see FIG. 2), for reference by the CPU 1. The RAM 3 is used as a working memory for temporarily storing various data generated as the CPU 1 executes predetermined programs, as a memory for temporarily storing a currently-executed program and data related to the currently-executed program, and for various other purposes. Predetermined address regions of the RAM 3 are allocated to various functions and used as various registers, flags, tables, temporary memories, etc. Performance operator unit 4A is, for example, a keyboard including a plurality of keys operable to select pitches of tones to be generated and key switches provided in corresponding relation to the keys. The performance operator unit 4A can be used not only for a manual performance by a user itself but also as a means for selecting a word (string of letter or letter string) displayed on a later-described “search screen” (FIG. 3) and the like. The detection circuit 4 detects depression and release of keys of the performance operator unit 4A to thereby produce detection outputs.

Setting operator unit 5A includes various operating members (i.e., operators), such as a search screen switch for causing the “search screen” (FIG. 3) to be displayed on a display device 6A, assignable operating members provided in corresponding relation to ON/OFFs of predetermined functions, displayed on the “search screen”, so as to enable any of the functions in response to user operation, and ± switch and dial switch capable of sequentially selecting words displayed on the “search screen”. Of course, the setting operator unit 5A may also include a numeric keypad for inputting numeric value data for selecting, setting and controlling a tone pitch, color, effect, etc., keyboard for inputting characters and letters, and various other operating members, such as a mouse operable to operate a predetermined pointer and the like displayed on the display device 6A. The detection circuit 5 detects an operating state of each of the operating members of the setting operator unit 5A and outputs switch information, corresponding to the detected operating state, etc. to the CPU 1 via the data and address bus 1D.

The display circuit 6 displays, on the display device 6A in the form of a liquid crystal display (LCD) panel, CRT or the like, not only various screens, such as the “search screen” but also various data currently stored in the ROM 2 and storage device 8, controlling states of the CPU 1, etc. In the instant embodiment, the user can easily designate search conditions for searching for a desired piece of music content, using the search screen displayed on the display device 6A, as will be later described in detail. The display device may be in the form of a touch-sensitive panel, in which case the electronic musical instrument, of course, includes a section for detecting that a screen has been touched.

The tone generator/effect circuit 7, which is capable of simultaneously generating tone signals in a plurality of tone generation channels, receives performance information (e.g., performance information based on accessed music content) supplied via the data and address bus 1D, and generates tone signals by performing tone synthesis on the basis of the received performance information. The tones signals generated by the tone generator/effect circuit 7 are audibly generated or sounded via a sound system 7A including an amplifier and speaker. The tone generator/effect circuit 7 and sound system 7A may be constructed in any desired conventionally-known manner. For example, the tone generator/effect circuit 7 may employ any desired tone synthesis method, such as the FM, PCM, physical model or formant synthesis method. Further, the tone generator/effect circuit 7 may be implemented by either dedicated hardware or software processing performed by the CPU 1.

The storage device 8 stores therein various data (music content data), such as automatic performance data and automatic accompaniment style data, and various control programs to be executed by the CPU 1. A database storing a multiplicity of pieces of music content may be built in the storage device 8. In a case where a particular control program is not prestored in the ROM 2, the control program may be prestored in the storage device (e.g., hard disk device) 8, so that, by reading the control program from the storage device 8 into the RAM 3, the CPU 1 is allowed to operate in exactly the same way as in the case where the particular control program is stored in the ROM 2. This arrangement greatly facilitates version upgrade of the control program, addition of a new control program, etc. The storage device 8 may use any of various removable-type recording media other than the hard disk (HD), such as a flexible disk (FD), compact disk (CD-ROM or CD-RAM), magneto-optical disk (MO) and digital versatile disk (DVD); alternatively, the storage device 8 may comprise a semiconductor memory, such as a flash memory.

The communication interface (I/F) 9 is an interface for communicating control programs and music content between the processing apparatus and not-shown external equipment (e.g., server apparatus). The communication interface 9 may be a MIDI interface, LAN, Internet, telephone line network or the like. It should be appreciated that the communication interface 9 may be of either or both of wired and wireless types.

In the aforementioned electronic musical instrument, the performance operator unit 4A may be of any other type than the keyboard instrument type, such as a stringed instrument type, wind instrument type or percussion instrument type. Furthermore, needless to say, the information processing apparatus of the present invention is not limited to the type where the performance operator unit 4A, display device 6A, tone generator/effect circuit 7, etc. are incorporated together as a unit within the apparatus. For example, the information processing of the present invention may be constructed in such a manner that the above-mentioned components are provided separately and interconnected via communication facilities such as a MIDI interface, various networks and/or the like.

The following paragraphs describe a piece of music content that is an object of search by the information processing apparatus of the present invention, with reference to FIG. 2. FIG. 2 is a conceptual diagram showing an example data organization of music content data.

As shown, each set of music content data comprises substantive music content data, and search word information for each of a plurality of items (three items, i.e. items 1-3, in the illustrated example) associated with the substantive music content data. The substantive music content data is an object of search. The substantive music content data as an object of search may be automatic performance data, automatic accompaniment style data, audio data, musical score data, performance environment setting data (indicative of at least one of tone color, tone volume, effect, automatic accompaniment settings, etc. to be used for a performance by the user). The search word information for each of the plurality of items defines a search condition of the item, and a word comprising a letter string recorded in the word information is displayed on the “search screen”. In other words, the search word information of the plurality of items are data that define, on an item-by-item basis, words to be displayed on the “search screen”.

The above-mentioned items are, for example, a name of the music content (Music Name), one or more specific or abstract keywords indicative of a character of the music content, a musical genre which the music content belongs to. In the instant embodiment, it is assumed that item 1 represents the music name, item 2 represents the keyword(s) and item 3 represents the genre. Namely, the music content includes, in addition to the substantive music content data, search information for each of a plurality of items (search items). The items for which words are recorded (or defined) may be of any desired criteria, and the number of the items may be any desired number greater than one.

The following describe the “search screen”, with reference to FIG. 3 that is a conceptual diagram showing an example of the search screen. This search screen, which is displayed on the display device 6A in response to operation of a search screen display switch or the like, assists the user to enter or designate search conditions for searching for a desired or target piece of music content from among a multiplicity of pieces of music content stored in a server apparatus, database, etc.

As shown in FIG. 3, the “search screen” comprises two major areas: a search condition display area A and an operator function display area B. On the basis of a control program and with reference to the above-mentioned music content database etc., the search condition display area A displays, in text format, words defined by item-specific search word information of individual pieces of music content, stored in the database or the like, mixedly or in a mixed manner, i.e. without the words being divided item by item. In the illustrated example, tags indicative of words belonging to the items of music names, keywords and genres of pieces of music content are displayed mixedly.

In FIG. 3, the letter strings “Music Name” each represent a name of a piece of music content just for simplicity of illustration; on the actual search screen, however, different words (e.g., specific or abstract music piece names like “Sakura” and “xxx Waltz”) are displayed in tagged text format in the positions of the letter strings “Music Name” in accordance with search word information defining the content names. If a word, such as one indicative of a name of a piece of music content, having a great number of letters is to be displayed, some portion(s) of the name may be extracted and displayed as a letter string(s) instead of the content name being displayed as a letter string in its entirety. In the case of a music piece name “Around a Season of Cherry Blossom”, for example, letter strings, such as “Cherry” and “Season”, having limited numbers of letters may be extracted and displayed.

The aforementioned can also be said for the letter strings “Keyword” and “Genre” in FIG. 3. Namely, on the actual screen, different letter strings, such as “Cheerful” and “Quiet”, are displayed in the positions of the letter strings “Keyword” in accordance with search word information defining keywords, and different letter strings, such as “Rock” and “Jazz”, are displayed in the positions of the letter strings “Genre” in accordance with search word information defining genres. The above-mentioned letter strings are displayed in a predetermined order, such as an English or Japanese alphabetical order. By displaying the letter strings in a predetermined order as noted above, the user can quickly visually grasp what kinds of letter strings are arranged on the screen and thus can easily find his or her desired word (search condition).

When tags of a plurality of words (letter strings), defining search conditions, are to be displayed in a “Tag Cloud” fashion or format, the instant embodiment displays a list of the tags of the words with a display style differentiated stepwise among the words. First, a display style is differentiated among the items (first display style); that is, the tags of the individual items are displayed in display styles differing among, i.e. unique to, the individual items. In the illustrated example of FIG. 3, such different or differentiated display styles are achieved by use of different forms and types of letters, e.g. by using ordinary letters to indicate music content names (Music Names), italic type letters to indicate keywords and underlined letters to indicate genres. In addition to the differentiation of the first display style among the items, another display style (second display style), different from the first display style, is differentiated or varied among the words in a predetermined order determined in accordance with a predetermined rule; in this case, a letter size is differentiated among the words. Of course, the display style differentiation employed in the instant embodiment is not limited to the aforementioned and may be achieved in any other suitable manner, such as by differentiating a displayed color, background color, font or the like of the words represented by the tags, or differentiating a design of the tags.

The above-mentioned predetermined rule may be, for example, a decreasing order of frequency of appearance of words among the multiplicity of pieces of music content stored in the server apparatus or database, decreasing order of the number of selections of words so far made by the user, decreasing order of the number of selections of words so far made by all users of the server apparatus or database (i.e., order of popularity), order in which the pieces of music content were registered (stored), or other suitable rule. Because all of the letters strings H (on the actual display, however, these letter strings H are of different content names) surrounded by dotted line in the illustrated example comprise ordinary letters and have a same letter size, it may be understood that these letters strings H are of the content name item and represent different search conditions of a same rank.

Namely, when a plurality of words (letter strings) are to be displayed on the search screen, the instant embodiment displays a list of the words with the respective display styles differentiated stepwise among the words in accordance with their items and in accordance with the predetermined order, so that the user can use the display as reference in designating a search condition(s) for selecting music content. Note that the predetermined rule may be only one or two or more of the above-mentioned rules.

When a word is to be selected on the search screen, the user only has to select any desired one of the words being displayed on the search screen, such as by operating the mouse or touch-sensitive panel to directly point to a desired one of the words being displayed or by operating the ± switch or dial switch until a desired one of the displayed words is reached. Once any desired one of the words is selected, pieces of music content belonging to the item represented by the selected word are searched, and then, the display device 6A shifts from the search screen to a list screen for displaying results the search. Then, the user can select a desired piece of music content from among the results the search, i.e. searched-for pieces of music content, displayed on the list screen.

If all of the words of the plurality of items are displayed at one time or at the same time, then there may be a possibility that the user can not efficiently find a desired word because the number of displayed words tends to be too great. Thus, the instant embodiment is constructed in such a manner that the user is allowed to operate any of the physical setting operating members 5A, disposed beneath the display device 6A, to appropriately set which of the plurality of items is to be selectively displayed on the search screen.

The setting operating members 5A disposed beneath the display device 6A are the assignable operating members, to which are assigned functions displayed in corresponding predetermined positions of the operating member display area B of the search screen. In the illustrated example of FIG. 3, three functions, music content name display ON (Name On), keyword display ON (KW ON) and genre display ON (Genre ON), are assigned to left three of the assignable operating members. According to a default of the search screen display (e.g., initial display of the search screen), all of the items are set in a display-ON state so that a tag cloud of words is mixedly displayed for all of the items in a tag-cloud format. By operating the setting operating member 5A corresponding to each to-be-deleted item for which the user wants to turn off the display, the user can delete the words belonging to the to-be-deleted item from the currently-displayed tag cloud so that these words are no longer displayed, or cause the words belonging to the to-be-deleted item to be gray-out displayed so that the user can not select the words belonging to the to-be-deleted item. When the words are deleted like this, positions where the words were located may be left blank, or words belonging to another item(s) than the to-be-deleted item may be moved to fill the positions where the words were located.

Thus, in a case where words (search conditions) of only a single item are to be displayed, i.e. where the user has already decided which one of the plurality of items is to be focused, only words of the single item (i.e., focused-on item) are displayed, so that there can be achieved the advantage that the user is allowed to efficiently perform content search by just finding a desired word from among the displayed words of the focused-on item without confusion. If, on the other hand, words of the plurality of items are mixedly displayed, there can be achieved the advantage that the user is allowed to perform content search while finding a desired word from a wide range of words of all of the items.

The following paragraphs describe a series of functions (processes) for displaying the aforementioned “search screen” on the display device 6A and searching pieces of content on the basis of a search condition designated on the “search screen”. FIG. 4 is a functional block diagram outlining the series of functions pertaining to content search. To facilitate understanding, the series of functions (processes) will be described in relation to a case where words pertaining to one piece of music content are displayed on the search screen.

Search word ranking sections J provide in corresponding relation to a plurality of items (item 1-item 3) each have one or more search conditions (words) belonging to the corresponding item (e.g., content name, keyword or genre of the music content) and orders or ranks these words in accordance with the aforementioned predetermined rule, and create a search word list of the ranked words. To create the search word list L, each of the search word ranking sections J acquires, from a user interface section U, history information of the words that have been selected so far by the user, or acquires, from a predetermined server (not shown), number-of-selection information of each word that has been selected so far by various users of the server.

To permit acquisition of the number-of-selection information from the not-shown server, whenever a user performs content search through the not-shown server via a communication network, each word entered by the user is uploaded to the server and stored as a search condition selection history, and the server performs counting per each word on the basis of the stored search condition selection history and ranks the words, for example, in accordance with the respective counted numbers of entries of the words. If the number of the words is enormous, it may be adjusted, for example, by limiting the number of words that are to be stored or limiting the number of words that are to be included in a search word list L to be created.

A mixing section M combines or mixes groups of one or more words included in the respective search word lists L of the items, and rearranges the thus-mixed words in a predetermined order, such as the alphabetical order, to thereby create a mixed search word list W. This mixed search word list W includes all of the words to be displayed on the “search list”, and these words are displayed on the “search screen” in the same order as in the mixed search word list W. A shaping section C reads a pre-prepared style sheet S (i.e., data defining setting information for display styles differing among, and hence unique to, the items and the ranks) and shapes each of the words on the basis of the style sheet S, i.e. sets for each of the words a display style in which the word is to be displayed on the “search screen”, to thereby create a shaped mixed search word list WL.

The user interface section U includes a display section U1 and a selection section U2, and the display section U1 displays, on the display device 6A, the “search screen” (see FIG. 3) where a tag cloud of the words is displayed on the basis of the shaped mixed search word list WL. If all of the words can not be displayed on the “search screen” at the same time, the display section U1 may display only the words of one or more relatively high ranks at the same time or display the words dividedly over a plurality of scrollable pages. Alternatively, the user may set ranks (or priorities) of the words to be displayed. For example, ranks 1-20 may be displayed as a default, and this display order may be changed so as to display words of ranks 21-40, ranks 41-60, etc. in response to operation by the user. In such a case, the display order may be gradually varied in range like ranks 1-20→ranks 2-21→ranks 3-22, or the range of the display order may be expanded or narrowed like ranks 1-20→ranks 1-40.

Once any one of the currently displayed words is selected by the user, the selection section U2 supplies a search section K with a search condition identified on the basis of the selected word, i.e. a search condition defined on the basis of an item determined in accordance with the display style unique to the item and the selected word and indicating which word of which item the selected word is. For example, for each individual word included in the search word list L of each of the items, a link is preset for accessing the search section K using the word as a search condition (namely, the word and the link are pre-defined in association with each other), so that, in response to user's selection of the word, the selection section U2 accesses the linked-to search section K with the search condition defined by the selected word.

The search section K searches, on the basis of the search condition supplied from the selection section U2, a multiplicity of pieces of music content stored in a music content storage section (such as a database) T to find one or more pieces of music content matching the supplied search condition, and then it returns a content list of results of the search to the user interface section U. The display section U1 of the user interface section U displays on the display device 6A a list of the results of the search on the basis of the returned content list. Then, the selection section U2, in response to user's selection of a piece of music content from among the displayed search results, permits use (acquisition, browsing or the like) of the selected piece of music content. Note that, if only one piece of content has been found as a result of the search, the search section K may directly present the one piece of content without presenting the list of the search results.

As set forth above, the instant embodiment of the invention is constructed in such a manner that, for a multiplicity of prestored pieces of object-of-search information (content), a list of groups of one or more words, belonging to individual ones of a plurality of items and stored in association with the pieces of object-of-search information (content) to indicate characters of the corresponding pieces of object-of-search information, are mixedly displayed on the display device 6A. At that time, the words are displayed in display styles differentiated among, and hence unique to, the plurality of items. Further, the words (more specifically, groups of one or more words) are displayed in other display styles, different from the item-specific display styles, that are differentiated stepwise among the words in accordance with their predetermined frequency. Further, in accordance with a search condition identified on the basis of the selected word from among one or more words displayed in the different display styles (this search condition indicates which word of which item the selected word is), pieces of object-of-search information imparted with the selected word are searched, and results of the search are displayed on the display device 6A. In this way, the instant embodiment allows the user to perform content search while knowing which item the selected word belongs to and visually recognizing the meaning of the word and thus permits efficient information search. Further, the instant embodiment allows the user to easily search pieces of information through AND search operations designating words across a plurality of items, which is very convenient.

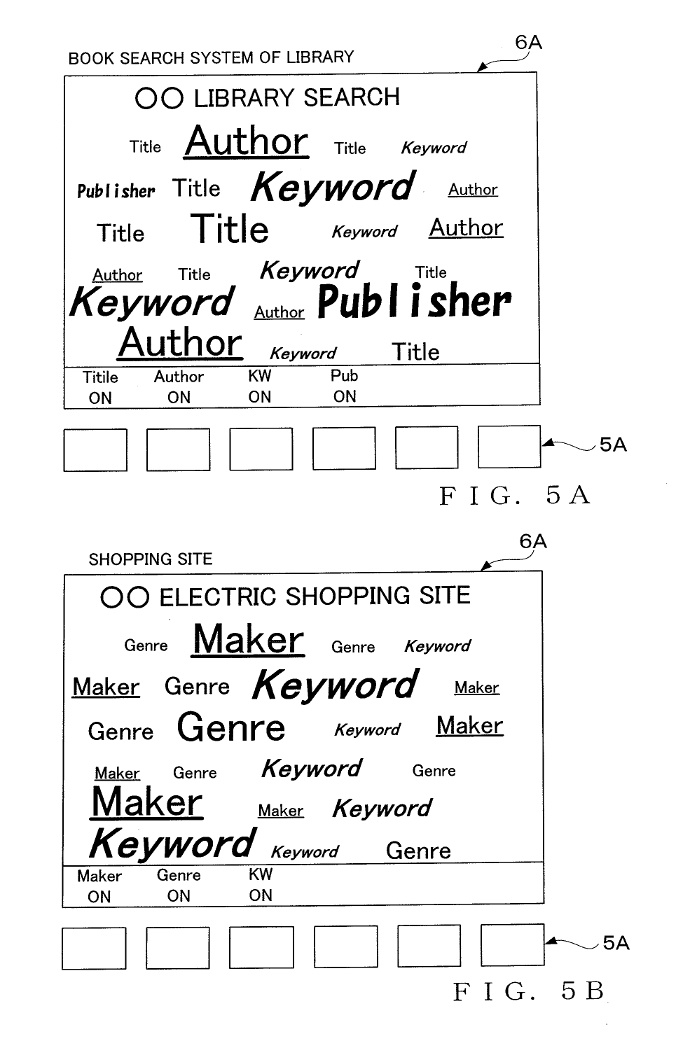

Furthermore, because the instant embodiment is constructed to selectively display only words (more specifically, groups of one or more words) belonging to a desired one or ones of a plurality of items, the user is allowed to efficiently search information of only the desired item(s) from among a multiplicity of pieces of object-of-search information.

Whereas the foregoing paragraphs have described the information processing apparatus of the present invention as applied to the electronic musical instrument capable of searching music content, it should be obvious to a person skilled in the art that the information processing apparatus of the present invention can also be applied to a system which searches a collection of books stored in a library, a system which searches products being sold in a shopping site deployed on the Internet, etc. FIG. 5A shows an example of a “search screen” displayed in a case where the information processing apparatus of the present invention is applied to part of a book search system, and FIG. 5B shows an example of a “search screen” displayed in a case where the information processing apparatus of the present invention is applied to part of a selling system in a shopping site deployed on the Internet.

On the “search screen” shown in FIG. 5A, a tag cloud of words for searching pieces of information pertaining to books stored, for example, in a library is displayed in different display styles unique to four items: “Title”; “Author”; “Keyword”; and “Publisher”. On the “search screen” shown in FIG. 5B, a tag cloud of words for searching pieces of sales information pertaining to electric appliances is displayed in different display styles unique to three items: “Maker”; “Genre” (product genre); and “Keyword”. In these cases too, the user is allowed to operate the physical setting operating members (switches) 5A, disposed beneath the display device 6A, to appropriately set which of the plurality of items is to be selectively displayed on the search screen. Behavior of the information processing apparatus of the present invention in the case where the information processing apparatus is applied to these systems is substantively the same as in the case where the information processing apparatus is applied to the electronic musical instrument and thus will not be described here to avoid unnecessary duplication.

The information processing apparatus of the present invention may be constructed to permit search refinement when objects of search, such as pieces of content or products, are to be searched. For example, when, in response to a first word selection, objects of search having the selected word imparted thereto have been searched out or extracted, a tag cloud of words imparted to the extracted objects of search is displayed. Then, the information processing apparatus of the present invention allows the user to search the extracted objects of search as new objects of search by designating a word from the tag-cloud-displayed words.

Note that the information processing apparatus of the present invention may be constructed to allow the user to select a plurality of words at the same time. For example, when the user sequentially selects a plurality of words while pressing a “Shift” button and then presses an “Enter” button, the selection section U2 of FIG. 4 may supply the search section K with a plurality of search conditions based on the selected words.

It should be appreciated that the information processing apparatus of the present invention may be applied to any other electronic music apparatus and equipment etc. than the electronic musical instrument as described above, such as personal computers, karaoke apparatus, game apparatus, portable communication terminals like portable phones and piano players. Of course, the information processing apparatus of the present invention may be applied to other apparatus than such electronic music apparatus and equipment as long as these apparatus are capable of searching objects of search (pieces of content). Further, the objects of search may be other than pieces of music content, such as pieces of software or hardware content, as long as they are searchable objects.

The terminal (apparatus) used by the user may be one functioning as a mere user interface with pieces of content (objects of search) and search engine provided in a server. In this case, the information processing apparatus of the present invention is applied to the server. Where a portable communication terminal is used by the user, for example, all of the above-described functions need not be provided in the portable communication terminal alone, in which case the server may have some of the above-described functions so that the above-described functions necessary for practicing the present invention can be achieved by an entire system that comprises the terminal and the server.

The present application is based on, and claims priority to, Japanese Patent Application No. 2009-002561 filed on Jan. 8, 2009. The disclosure of the priority application, in its entirety, including the drawings, claims, and the specification thereof, is incorporated herein by reference.

What is claimed is:

1. An information processing apparatus for searching a multiplicity of objects of search for an object of search meeting a search condition, comprising:
a display device;
a storage section which stores therein groups of one or more words in association with individual ones of the multiplicity of objects of search, each of the groups of one or more words indicating a character of a corresponding one of the objects of search, the multiplicity of objects of search being classified redundantly into a plurality of items, said storage section storing therein, for each of the items, at least one group of one or more words indicating a character of a corresponding one of the objects of search;
a control section which mixedly displays, on a screen of said display device and with reference to said storage section, tags indicative of groups of one or more words, each indicating a character of a corresponding one of the objects of search, for individual ones of the plurality of items, said control section displaying the tags in different display styles unique to the individual items, an image of each of the tags being variable stepwise in accordance with a predetermined display variation condition;
a selection section which accepts user's operation for selecting a desired tag from among the tags displayed on the screen of said display device;
a search section which, with reference to said storage section, searches for an object of search meeting a search condition identified on the basis of the one or more words indicated by the tag selected by the user; and
a result-of-search presentation section which visually displays on said display device a result of the search performed by said search section.

2. The information processing apparatus as claimed in claim 1, wherein the different display styles unique to the individual items are provided by differentiating a front of the one or more words, indicated by the tag, between the items.

3. The information processing apparatus as claimed in claim 1, wherein the different display styles unique to the individual items are provided by differentiating a form of the one or more words, indicated by the tag, between the items.

4. The information processing apparatus as claimed in claim 1, wherein the different display styles unique to the individual items are provided by differentiating a color of the one or more words, indicated by the tag, between the items.

5. The information processing apparatus as claimed in claim 1, wherein the different display styles unique to the individual items are provided by differentiating a background color of the one or more words, indicated by the tag, between the items.

6. The information processing apparatus as claimed in claim 1, wherein the different display styles unique to the individual items are provided by differentiating a design of the words, indicated the tag, between the items.

7. The information processing apparatus as claimed in claim 1, which further comprises a second selection section which selects one or more of the items to be displayed, and wherein, for the one or more items selected by said second selection section, said control section mixedly displays, on the screen of said display device, tags each indicative of a group of one or more words indicating a character of a corresponding one of the objects of search.

8. An information processing apparatus for searching a multiplicity of objects of search for an object of search meeting a search condition, comprising:
a display device;
a storage section which stores therein groups of one or more words in association with individual ones of the multiplicity of objects of search, each of the groups of one or more words indicating a character of a corresponding one of the objects of search, the multiplicity of objects of search being classified redundantly into a plurality of items, said storage section storing therein, for each of the items, at least one group of one or more words indicating a character of a corresponding one of the objects of search;
an item selection section which selects one or more of the items to be displayed;
a control section which mixedly displays, on a screen of said display device and with reference to said storage section, tags indicative of groups of one or more words, each indicating a character of a corresponding one of the objects of search, for individual ones of the plurality of items, said control section displaying the tags in different display styles unique to the individual items, an image of each of the tags being variable stepwise in accordance with a predetermined display variation condition;
a tag selection section which accepts user's operation for selecting a desired tag from among the tags displayed on the screen of said display device;
a search section which, with reference to said storage section, searches for an object of search meeting a search condition identified on the basis of the one or more words indicated by the tag selected by the user; and
a result-of-search presentation section which displays on said display device a result of the search performed by said search section.

9. A computer-implemented method for searching a multiplicity of objects of search for an object of search meeting a search condition, comprising:
a step of providing a memory which stores therein groups of one or more words in association with individual ones of the multiplicity of objects of search, each of the groups of one or more words indicating a character of a corresponding one of the objects of search, the multiplicity of objects of search being classified redundantly into a plurality of items, said memory storing therein, for each of the items, at least one group of one or more words indicating a character of a corresponding one of the objects of search;
a control step of mixedly displaying, on a screen of a display device and with reference to said memory, tags indicative of groups of one or more words, each indicating a character of a corresponding one of the objects of search, for individual ones of the plurality of items, said control step displaying the tags in different display styles unique to the individual items, an image of each of the tags being variable stepwise in accordance with a predetermined display variation condition;
a selection step of accepting user's operation for selecting a desired tag from among the tags displayed on the screen of the display device;
a search step of, with reference to said memory, searching for an object of search meeting a search condition identified on the basis of the one or more words indicated by the tag selected by the user; and
a step of visually displaying on the display device a result of the search performed by said search step.

10. The computer-implemented method as claimed in claim 9, which further comprises a selection step of selecting one or more of the items to be displayed, and wherein, for the one or more items selected by said selection step, said control step mixedly displays, on the screen of the display device, tags each indicative of a group of one or more words indicating a character of a corresponding of the objects of search.

11. A computer-readable storage medium containing a program for causing a computer to perform a method for searching a multiplicity of objects of search for an object of search meeting a search condition, said method comprising:
a step of providing a memory which stores therein groups of one or more words in association with individual ones of the multiplicity of objects of search, each of the groups of one or more words indicating a character of a corresponding one of the objects of search, the multiplicity of objects of search being classified redundantly into a plurality of items, said memory storing therein, for each of the items, at least one group of one or more words indicating a character of a corresponding one of the objects of search;
a control step of mixedly displaying, on a screen of a display device and with reference to said memory, tags indicative of groups of one or more words, each indicating a character of a corresponding one of the objects of search, for individual ones of the plurality of items, said control step displaying the tags in different display styles unique to the individual items, an image of each of the tags being variable stepwise in accordance with a predetermined display variation condition;
a selection step of accepting user's operation for selecting a desired tag from among the tags displayed on the screen of the display device;
a search step of, with reference to said memory, searching for an object of search meeting a search condition identified on the basis of the one or more words indicated by the tag selected by the user; and
a step of visually displaying on the display device a result of the search performed by said search step.

12. The computer-readable storage medium as claimed in claim 11, which further comprises a second selection step of selecting one or more of the items to be displayed, and wherein, for the one or more items selected by said second selection step, said control step mixedly displays, on the screen of the display device, tags each indicative of a group of one or more words indicating a character of a corresponding one of the objects of search.
